(19) United States
(12) Patent Application Publication
(10) Pub. No.: US 2023/0105911 A1
(43) Pub. Date: Apr. 6, 2023

(54) Method for determining a recommendation of a gear to be engaged for a core drill, and core drill

(71) Applicant: Hilti Aktiengesellschaft, Schaan (LI)

(72) Inventor: Christian SATTLER, Biessenhofen (DE)

(21) Appl. No.: 17/800,230

(22) PCT Filed: Feb. 23, 2021
(86) PCT No.: PCT/EP2021/054410

§ 371 Date: Aug. 17, 2022

(30) Foreign Application Priority Data
Mar. 5, 2020 (EP) 20161154.8

(51) Int. Cl. B23B 35/00; B23B 45/00

(52) U.S. Cl. CPC B23B 35/00; B23B 45/008; B23B 2270/486

(57) ABSTRACT

A method for determining a recommendation of a gear to be engaged for a core drill. In the method, it is possible to use for example a drop in a rotational speed of a core bit of the core drill in the event of sudden deactivation of the motor of the core drill in order to determine the diameter of the core bit. Alternatively, the diameter of the core bit can be determined when the drill is started up or turned on. The diameter of the core bit is then used as the basis for the recommendation of the gear to be engaged. In a second aspect, the invention relates to a core drill with which the method can be carried out.

The present invention relates to a core drill and a method for determining a recommendation of a gear to be engaged for a core drill.

### BACKGROUND OF THE INVENTION

Core drills, with which cylindrical drilling cores can be cut out of a substrate, such as concrete or masonry, are known from the prior art. These core drills have core bits as tools, wherein core bits with different diameters can be used in order to create boreholes of different sizes. Furthermore, it is known from the prior art that core drills have a transmission in order that a user of the drill can select and set a gear for the operation of the core drill. The user can select the gear in accordance with the requirements of the planned drilling work or the substrate. In the considerations that precede the selection or setting of the gear, it is possible for example for the desired torque, the diameter of the core bit to be used or a desired rotational speed thereof to play a role.

### SUMMARY OF THE INVENTION

However, tests have shown that users of core drills frequently do not carry out the assignment of core bit diameter and selected gear or do not carry it out optimally. This can have the disadvantageous result of the core drill working with a non-optimal torque and/or a non-optimal rotational speed of the core bit for a specific task. As a result, difficulties can arise on carrying out the drilling work or delays can occur. It is also possible for the quality of the drilling result to suffer as a result of non-optimally set gears on the core drill.

There are no adequate and easily implementable solutions in the prior art in the field of core drills for identifying the core bit diameter or for displaying a gear recommendation or for preferably automatic gear selection for core drills.

Previously, the user has had to acquire information about the correct gear selection for the core bit diameters used themselves. Therefore, core bits are often used in the wrong gear or drilling is carried out with a core bit in a gear that is “wrong” for the core bit diameter. This can disadvantageously result in a reduced drilling speed and/or an undesired shortening of the lifetime of the core bit.

It is an object of the present invention to provide the user of a core drill with a recommendation of an optimal gear selection. Such a gear selection recommendation is known for example in passenger cars, in which an indication with an arrow frequently occurs on the display. This indication can have for example as content the gear that is currently engaged and whether the currently engaged gear is optimal for the motor and/or the transmission in light of the current motor speed or whether a different gear should be engaged. The gear selection recommendation should, as far as possible, occur and be displayed automatically in order that the user can notice and implement it without great effort. The invention is based in particular on the object of providing a method for displaying a recommended gear or a method for the preferably automatic setting of the optimal gear for a particular core bit diameter for working with the core drill.

According to the invention, a method for determining a recommendation of a gear to be engaged for a core drill is provided. The method is characterized in that a function n(t) that describes the rotational speed n of a core bit of the core drill as a function of time t is used in order to determine a diameter of the core bit of the core drill, wherein the determined diameter of the core bit is used as the basis for the recommendation of the gear to be engaged. In one configuration of the invention, it is preferred that the function n(t) describes a drop in the rotational speed after a motor of the core drill has been deactivated. In other words, with the method, a drop in the rotational speed of the core bit is used to determine a diameter of the core bit of the core drill, wherein the determined diameter of the core bit is used as the basis for the recommendation of the gear to be engaged. In this configuration of the invention, it is preferred that the function n(t) is recorded during operation of the core drill.

In an alternative configuration of the invention, it may be preferred that the motor of the core drill is not deactivated, but rather a reduction in the drive torque of the motor is enough for determining the rotation energy of the core bit. According to the invention, it may also be preferred that the rotation energy of the core bit is determined when the motor is started. In this configuration of the invention, it is preferred that the function n(t) is recorded at a start-up of the core drill. This configuration of the invention is particularly advantageous because, in this way, the performing of the method can be integrated into the normal work process when using a drill. The user preferably notices no delay in the work procedure and feels less disturbed or stopped from working. This increases the working efficiency when working with the drill, which is designed to implement the method. According to the invention, it is very particularly preferred that the change in rotational speed of the core bit is determined in order to derive the rotation energy of the core bit therefrom.

The invention relates in particular to a method for automatically identifying the core bit diameter in core drills, and to the displaying and/or processing of this information. With this information, it is possible to provide the user with a recommendation for the gear selection on the core drill and thus to improve the drilling speed and/or the lifetime of the core bit. Tests have shown that, with the method, the drilling performance of the core drill can be improved considerably. The identification of the core bit diameter can preferably be used to provide the user of the core drill with an optimal gear selection recommendation for working with the core drill.

An essential advantage of the invention is that a recommendation for the “correct” gear selection for the core bit diameter used is displayed for the user of the core drill. In this case, the “correct” or optimal gear, in relation to the rotational speed and/or torque, for the core bit diameter used can advantageously be selected and/or set automatically by the core drill.

A particular advantage of the invention is that, with the method, existing measured variables are used in a measurement cycle in order to specify a gear selection recommendation. The term “measurement cycle” stands in this connection preferably for the time period in which the rotation energy of the core bit is determined in order to derive the core bit diameter therefrom.

According to the invention, the term “existing measured variables” means preferably that these are measured variables that are determined by the core drill independently of the method. An example of an existing measured variable is for example the rotational speed of the core bit of the core drill. Preferably, the existing measured variables can be evaluated in order to arrive at the gear selection recommendation for the user of the core drill. Advantageously, the method is able to be implemented with the existing, i.e. the available drive hardware, since when the method is carried out preferably only a control method used for controlling the core drill is changed. In other words, in the context of the present invention, it may be preferred to adapt control software of the core drill in order to determine and display a gear selection recommendation.

The solution presented here represents in particular a method for the preferably automatic identification of the core bit diameter in order for it to be possible to derive therefrom an optimal gear for the determined core bit diameter, for operating the core drill. The method uses preferably the measured variable of “rotational speed” in conjunction with a defined measurement cycle. A constituent of this measurement cycle is in particular a short time period Δt in which the core drill or the motor of the core drill is deactivated. A basis for the method is the rotation energy that varies greatly depending on the core bit diameter, on the basis of the very different moments of inertia. These readily measurable and accessible existing measured variables are used, in the method, in order to determine an optimal gear for the determined core bit diameter, for operating the core drill.

According to the invention, it is preferred that, for the measurement cycle, the motor of the drill is deactivated for a defined time period Δt such that a jump function can be observed in the rotational-speed function and the reaction of the system can be taken into consideration on the basis of the drop in rotational speed. The reaction of the core drill comprises in particular a negative acceleration, which, according to the invention, is referred to preferably as a drop in rotational speed. According to the invention, it is preferred that the negative acceleration is caused by the brief deactivation of the motor of the core drill.

A further advantage of the invention is that there is no system link. This preferably means, according to the invention, that the diameter of a core bit can be realized advantageously independently of the producer of the core bit.

In a particularly preferred configuration, the invention relates to a method for determining a recommendation of a gear to be set for a core drill, wherein the method is characterized by the following method steps:
a) operating a core drill with a core bit as tool,
b) switching off the core drill for a predetermined time period Δt,
c) registering the rotational speed n of the core bit as a function of time t, with the result that a function n(t) is obtained,
d) evaluating the function n(t),
e) determining a diameter of the core bit on the basis of the evaluated function n(t),
f) establishing and/or displaying a recommendation of a gear to be engaged for the core drill on the basis of the determined diameter of the core bit.

The invention is based on the idea that the motor of the core drill is deactivated for a defined time period Δt such that there is a jump function in the plot of the rotational speed n over time t. Usually, as a result of the deactivation of the motor of the core drill, the rotational speed of the core bit of the core drill will drop. The manner in which the rotational speed drops can preferably be used to arrive at a gear selection recommendation that can be displayed to the user of the core drill. In other words, the reaction of the core drilling system on the basis of the drop in rotational speed can be considered in order to determine the core bit diameter and to derive a gear recommendation for the core drill.

According to the invention, it is particularly preferred that the drop in the rotational speed n of the core bit is evaluated. Preferably, this drop in rotational speed can be brought about by switching off the motor of the core drill. The core bit diameter can then preferably be determined or derived on the basis of the registered and/or analyzed drop in rotational speed. In a subsequent method step, a recommendation for the gear to be engaged for the core drill can be established and/or displayed on the drill. To this end, the core drill can comprise for example corresponding display means, such as a display, a monitor, a touchscreen or optical display means, such as LEDs or indicator lamps in different colors.

In a core drill, the rotational speed of the core bit is related to the fourth power of the diameter of the core bit via the moment of inertia J and the rotation energy Er. This makes it possible that, with the method, depending on the core bit used and the associated moment of inertia J, different profiles of the rotational speed function n(t) can be measured. In particular, different profiles for the drop in rotational speed arise depending on the diameter of the core bit that is currently being used as tool on the core drill. Since the rotation energy Er is dependent on the fourth power of the core bit diameter, considerable differences in rotation energy Er arise even with small differences in the diameter of the core bits to be distinguished between. The inventor has found that this circumstance is reproduced or reflected in the rotational speed response at the core drill, such that the rotational speed response of the core drill can be used, in the event of a brief deactivation or when turning on or starting up the drill, to derive a gear selection recommendation and display it to the user. Preferably, the rotational speed response of the core drill can be described by the function n(t).

According to the invention, it is preferred that the diameter of the core bit is determined using look-up tables. In this case, the data obtained on carrying out the method are compared with a look-up table and the core bit diameters are derived on the basis of the comparison. The look-up tables can be saved in a memory device of the drill. The look-up tables can also be saved in a cloud or on a server, however. In this case, it is preferred that the drill has communications means that are designed such that the drill enters into a communication connection with the cloud and/or the server, i.e. can communicate with the cloud and/or the server.

According to the invention, it is preferred that the time period Δt is in a range from 0.1 to 5 s, preferably in a range from 0.25 to 2 s, particularly preferably in a range from 0.4 to 1 s, and is most preferably 0.5 s. In other words, the motor of the core drill can be deactivated for example for a time period of 0.1 to 5 s, preferably of 0.25 to 2 s, particularly preferably for a time period of 0.4 to 1 s and most preferably for a time period of 0.5 s in order to analyze the subsequent change in the rotational speed function n(t). In this case, a time period of about 0.5 s has proven to be particularly suitable in order to derive an optimal gear selection recommendation. According to the invention, it is particularly preferred that the core drill is switched off by switching off its motor. According to the invention, it is preferred that the time period Δt is kept as short as possible and is in particular less than 1 s. For example, periods of time of between 200 and 500 ms may be particularly preferred. For example, measurement cycles can be carried out in which, for example, in each case 10 individual measurements are taken. The duration of an individual measurement can last for example 20 ms such that a time period Δt of about 200 ms is achieved. The advantage of a time period Δt that is as short as possible is that the measurement cycle is then hardly noticed or found to be disruptive or a delay by a user of the drill.

According to the invention, it is preferred that the core drill is operated in a speed control mode before it is switched off. Preferably, the core drill is operated in a speed control mode before the motor of the core drill is switched off.

In a second aspect, the invention relates to a core drill for carrying out the method, wherein the core drill has a core bit as tool. The core drill is characterized in that a recommendation of a gear to be engaged for a core drill and/or a diameter of the core bit of the core drill is/are able to be determined by evaluating a function n(t) of the rotational speed n of the core bit as a function of time. According to the invention, it is very particularly preferred that a drop in the rotational speed of the core bit of the core drill is used in order to determine a gear to be engaged for the core drill and/or to determine the diameter of the core bit of the core drill. The terms, definitions and technical advantages introduced for the method apply preferably in an analogous manner to the core drill.

According to the invention, it is preferred that, for identifying the core bit diameter using a rotational speed measurement in a measurement cycle, the core bit is mounted firmly in the tool fitting of the core drill. Preferably, the core bit is free of drilling debris. It is also preferred that the core drill is operated in the speed control mode and the core bit rotates in a manner substantially free of external loads. Furthermore, according to the invention, it is preferred that the length and the wall thickness of the core bits to be distinguished between are similar to one another within certain limits.

The motor of the drill is preferably deactivated for a defined time period Δt such that a jump in the rotational speed function n(t) can be observed. Preferably, as a result, the reaction of the core drilling system to the brief deactivation of the core drill can be considered on the basis of the drop in rotational speed.

Depending on the core bit diameter used and on the associated moment of inertia J, a different drop in rotational speed can be measured. Because the rotation energy Er is dependent on the fourth power of the core bit diameter, considerable differences in rotation energy Er can be identified even with small differences in core bit diameter. Tests have shown that these considerable differences are reproduced advantageously in the rotational speed response at the core drill.

The inventor has found that the different moments of inertia have an effect in the form of a drop in the rotational speed of the core bit such that they can be easily measured and evaluated in the scope of the method in order to recommend an optimal gear for the core drill. It has been found that the system with expansion of the diameter limits becomes less critical with regard to the length of the core bit.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a view of a preferred configuration of the invention.

### DETAILED DESCRIPTION

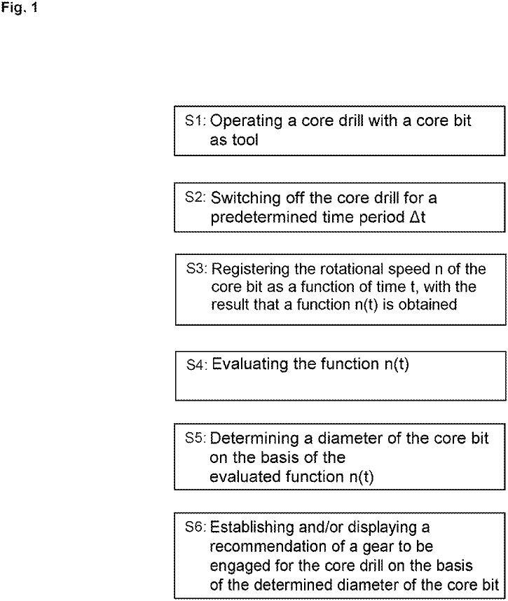

FIG. 1 shows a preferred configuration of the invention. In particular, FIG. 1 shows a configuration of the invention in which the function n(t) is recorded during operation of the core drill. A preferred embodiment of this method can have for example the method steps S1 to S6. In a first method step S1, a core drill having a core bit as tool is operated. In a second method step S2, the core drill is switched off for a predetermined time period Δt. In this case, in a third method step S3, the rotational speed n of the core bit is registered as a function of time t such that a function n(t) is obtained. In a fourth method step S4, this function n(t), which describes the profile of the rotational speed over time, is evaluated. This can be done using mathematical operations or by consulting look-up tables. As a result of the evaluation of the function n(t), in a fifth method step S5, the diameter of the core bit can be determined. Advantageously, in a subsequent sixth method step S6, a recommendation of a gear to be engaged can be determined for the core drill on the basis of the determined diameter of the core bit. Furthermore, this gear recommendation can be displayed by the corresponding display means on the drill.

In an alternative embodiment of the invention, the function n(t) can be recorded at a start-up of the core drill.

What is claimed is:

1-8. (canceled)

9. A method for determining a recommendation of a gear to be engaged for a core drill, comprising:
using a function n(t) describing a rotational speed n of a core bit of the core drill as a function of time t is used in order to determine a diameter of the core bit of the core drill; and
using the determined diameter of the core bit as a basis for the recommendation of the gear to be engaged.

10. The method as recited in claim 9 wherein the function n(t) is recorded at a start-up of the core drill.

11. The method as recited in claim 9 wherein the function n(t) is recorded during operation of the core drill.

12. The method as recited in claim 11 further comprising:
a) operating the core drill with the core bit as a tool,
b) switching off the core drill for a predetermined time period Δt,
c) registering the rotational speed n of the core bit as a function of time t so as to obtain the function n(t),
d) evaluating the function n(t),
e) determining the diameter of the core bit on the basis of the evaluated function n(t),
f) establishing or displaying a recommendation of the gear to be engaged for the core drill on the basis of the determined diameter of the core bit.

13. The method as recited in claim 11 wherein the function n(t) describes a drop in the rotational speed after a motor of the core drill has been deactivated.

14. The method as recited in claim 12 wherein the time period Δt is in a range from 0.1 to 5 s, preferably in a range from 0.25 to 2 s, particularly preferably in a range from 0.4 to 1 s, and is most preferably 0.5 s.

15. The method as recited in claim 14 wherein the time period Δt is in a range from 0.4 to 1 s.

16. The method as recited in claim 15 wherein the time period Δt is 0.5 s.

17. The method as recited in claim 12 wherein the core drill is operated in a speed control mode before it is switched off.

18. A core drill for carrying out the method as recited in claim 9 wherein the recommendation of a gear to be engaged for a core drill or the diameter of the core bit of the core drill are able to be determined by evaluating the function n(t) of the rotational speed n of the core bit as a function of time t.
